(19) United States
(12) Patent Application Publication
(10) Pub. No.: US 2015/0229186 A1
(43) Pub. Date: Aug. 13, 2015

(54) AXIAL INDUCTION MACHINE

(71) Applicant: Paul Sauer, Los Angeles, CA (US)

(72) Inventor: Paul Sauer, Los Angeles, CA (US)

(21) Appl. No.: 14/175,909

(22) Filed: Feb. 7, 2014

(51) Int. Cl. H02K 9/197; B23P 15/26; F28D 15/00

(52) U.S. Cl. CPC H02K 9/197; F28D 15/00; B23P 15/26

(57) ABSTRACT

Disclosed is a liquid cooling system for an electric machine including a heat exchanger conductively attachable to a stator of an electric machine. The liquid cooling system further includes a cover mechanically attached to the frame and fluidly sealed to the frame, the cover and frame defining a cavity there between. The cover includes at least one protrusion extending substantially a distance between the cover and the frame. A method for constricting a liquid for efficient heat transfer is also provided. The method includes forming at least one protrusion in the cover and structurally affixing the cover to the frame. The cover is fluidly sealed to the frame.

### CO-RELATED APPLICATIONS

This non-provisional application claims the entire benefit of a provisional application entitled “Axial Induction Machine”, filed on Feb. 8, 2013 and having Ser. No. 61/762,648, wherein all the above-referenced applications were filed by the same inventor.

### BACKGROUND OF THE INVENTION

The present invention relates generally to electric machines and more particularly axial induction machines. More specifically, this invention relates to an improved liquid cooling system for an axial induction machine.

As higher voltage and higher power axial induction machines are utilized in vehicles and the like, a problem regarding the fact that such axial induction machines produce an increasing amount of heat is realized. Excess heat must be dissipated to preserve the reliability and efficiency of the axial induction machine. In many applications, the amount of heat is great enough that a liquid cooling system is used to dissipate heat from the axial induction machine.

Prior liquid cooling systems have utilized a cooling jacket in thermal contact with the axial induction machine, and a fluid is circulated through the cooling jacket to transfer heat from the jacket into the fluid, which then is carried from the cooling jacket to a heat loss device. One type of cooling jacket is a double-walled cast aluminum cooling jacket. The constraints of casting design and fabrication result in a cooling jacket of substantial thickness. Since the overall package size of the axial induction machine is usually restricted by available space in, for example, a vehicle, the cast cooling jacket thickness is disadvantageous because it limits space available for an axial induction machines stator and thereby limits the performance of the axial induction machine.

A second type of cooling jacket, a brazed steel assembly, has been used in an effort to reduce the cooling jacket thickness. The brazed joints, however, have low mechanical strength and are vulnerable to cracking under vibration, which will result in a fluid leak and potential failure of the electric machine. The brazed cooling jackets are less efficient at heat transfer because the interior of the jackets have a decreased surface area simply due to a smaller diametrical dimension of the outer surface of the cooling jacket as compared to that dimension of the cast jacket, which as noted must be thicker. Additionally, because the interior walls of the brazed cooling jackets are smooth compared to the cast cooling jacket, the result is a less turbulent flow of the cooling fluid through the jacket, and consequently less effective cooling.

Although prior art systems do indeed reduce operating temperatures of axial induction machines, there currently is a need to provide an improved cooling ability which reduces the axial induction machines footprint and at the same time reduces cost resulting in improved longevity.

### SUMMARY OF THE INVENTION

The present invention solves the aforementioned problems by providing an end-bell housing having a built-in liquid cooling system with much higher efficiency. The liquid cooling system is provided by interiorly designed fluid flow paths defined within the end-bell housing. The end-bell housing provides an enclosure for housing the stators and rotors of the axial induction machine. The liquid cooling system further includes a lid mechanically attached to the end-bell and fluidly sealed to the end-bell wherein the lid and end-bell define a cavity there between which once assembled form the interiorly designed fluid flow paths. Additionally, the end-bell includes a fluid inlet and a fluid outlet for controlling fluid flow rate, pressure differential and temperature.

A method for constricting a liquid for efficient heat transfer is also provided. The method includes forming at least one or more protrusions in the lid and structurally affixing the lid to the end-bell.

### DESCRIPTION OF THE DRAWINGS

The above, as well as other advantages of the present invention will become readily apparent to those skilled in the art from the following detailed description of preferred embodiments when considered in the light of the accompanying drawings in which:

FIG. 1 illustrates an example of an assembled axial induction machine with an improved liquid cooling system in accordance with the present invention;

FIG. 2 illustrates a perspective view of an example of the axial induction machine of FIG. 1 in a disassembled exploded state;

FIG. 3 is a schematic axial view of a cavity of the liquid cooling system of FIG. 2, showing directing of the coolant flow;

FIG. 4 is a plan view of a cavity illustrating a first example of a protrusion configuration showing the flowpath in 3-d space;

FIG. 5 is another embodiment, showing a plan view assembly of an add-on liquid-cooling system and its associated end bell assembled for providing heat transfer according to the present invention;

FIG. 6 illustrates an perspective showing a lid, a fluid channel housing and its associated end bell for providing heat transfer according to the present invention; and

FIG. 7 is an assembled perspective view of the fluid channel housing and its associated end bell from FIGS. 5 and 6 showing the coolant flow path.

### DETAILED DESCRIPTION OF THE INVENTION

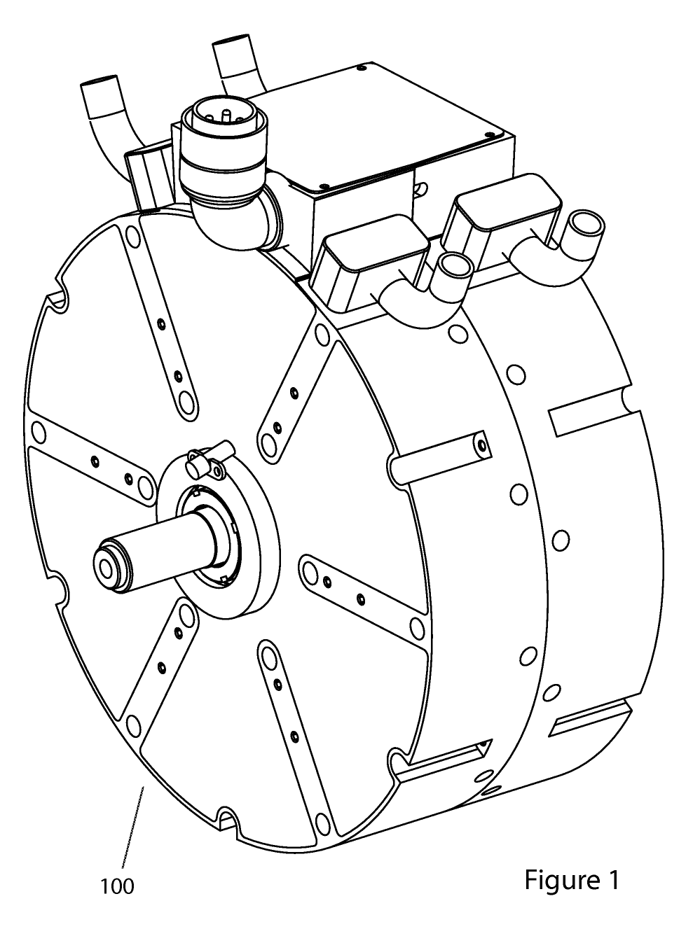

Referring now to FIG. 1, there is shown a fluid-cooled axial induction machine 100 in accordance with the present invention. The type of electric machine shown in FIG. 1 may be a belt-driven alternator starter (BAS), but applications of this invention to other electric machines such as generators and/or alternators are contemplated. FIG. 1 illustrates an example of an assembled axial induction machine. In one example, the axial induction machine serves as an electric generator. In another example, the axial induction machine may be used as a motor. Regardless of the use of the induction machine, whether used as a motor or generator, heat is generated by the machine during use and therefore heat dissipation is needed.

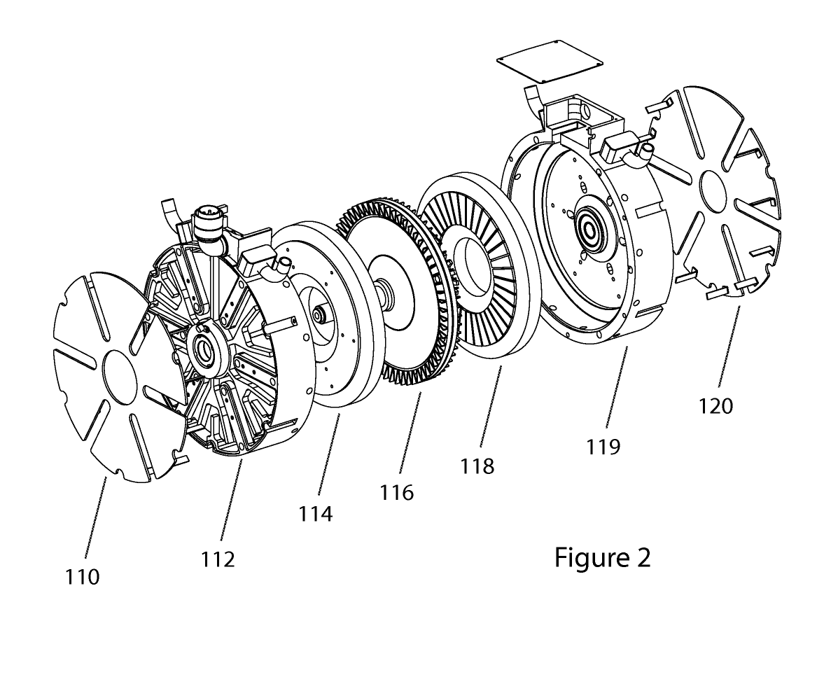

Turning now to FIG. 2 there is shown a perspective view of an example of the axial induction machine of FIG. 1 in a disassembled state. As shown in FIG. 2, the axial induction machine 100 includes the following components: lid 110, end bell 112, stator 114, rotor 116, stator 118, end bell 119 and lid 120. One skilled in the art would understand that the components called out and/or visible in FIG. 2 are for illustrative purposes and not limiting. For example, other components (either not shown or not called out) may be included in the axial induction machine 100 without affecting the scope and spirit of the present disclosure. Additionally, one skilled in the art would understand that one or more of the components (showed or called out) may not be included in the axial induction machine 100 while still not affecting the scope and spirit of the present disclosure. In the illustrated example, the axial induction machine 100 includes one rotor 116 and two stators 114 and 118, respectively. Although not shown, it should be understood that a variety of configurations make up an axial induction machine, which by way of example could be two rotors and one stator.

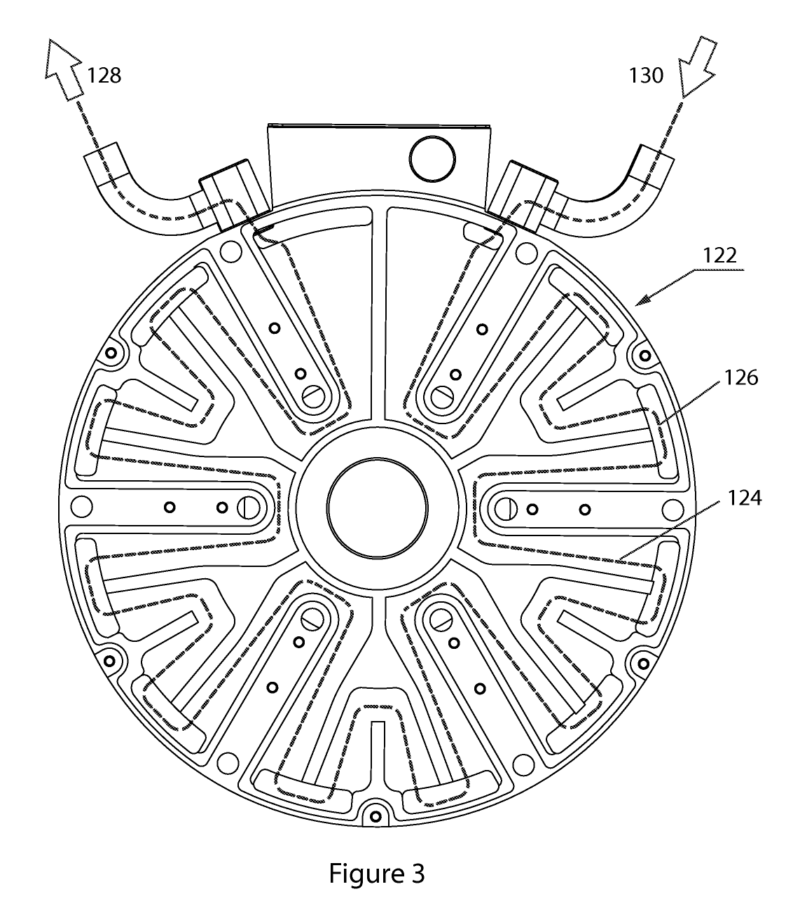

Turning once again to FIG. 2, stator 114 is coupled and affixed to end-bell 112 in a manner that provides good thermal contact and thermal conductivity between them. As shown and in this example, stator 114 is a mirror image of stator 118 and end-bell 112 is a mirror image of end-bell 119. The rotor 116 spins and is coupled to end-bells 112 and end-bell 119 by use of stators 114 and 118, respectively. Referring now to FIG. 3 there is shown a schematic axial view of a cavity of the liquid cooling system of FIG. 2 wherein fluid enters at one point 130 on the circumference of end-bell 112 and exits at another point 128 on the circumference (e.g., at the far end). More specifically and in the example shown in FIG. 3, the fluid enters through a fluid inlet 130 and exits through the fluid outlet 128. The fluid may be a coolant, water, or gas. It should be understood that for a particular axial induction machine 100, the type of fluid used for cooling may be varied depending on the application and/or user choice. One skilled in the art would understand that the list of fluids disclosed herein is not restrictive, and that other types of fluids may be used without affecting the scope and spirit of the present disclosure,

Turning once again to FIG. 2, in this example or preferred embodiment, a lid 110 is used to seal the fluid flowing in end-bell 112 by attaching the lid 110 by any sealant means known in the arts such as brazing, welding, use of high strength thermal epoxy's etc. Additionally, using one or more sealing means previously described, the fluid flow is sealed between each section of the axial induction machine 100 during assembly. The fluid path is designed to allow the fluid to flow through the circumference of the end-bell 112 enclosure so as to provide substantial (e.g., maximum) heat dissipation for the axial induction machine 100.

Turning once again to FIG. 3, end bell 112 defines a plurality of symmetrical fluid cavities 122 which are dimensioned to provide the appropriate heat transfer to the rotor 116 as the rotor 116 spins (not shown) as will be more fully described below. More specifically, there are defined machined channels 124 for allowing the fluid to flow radially outward at a given pressure and flow rate and a set of outer angular channels 126 connecting the radial channels 124 for forming a complete and unified fluid pathway for the fluid entering 130 the end bell 112 and exiting 128 the end bell 112 as is shown in FIG. 3. The fluid properties such as flow rate, viscosity, fluid pressure and temperature are maintained by the channels formed in end bell 112 when fully assembled which allows for much greater rotational speeds for the rotor and stators 116 and 114, respectively by removing heat which in turns generates more electrical power than known by prior art axial induction machines.

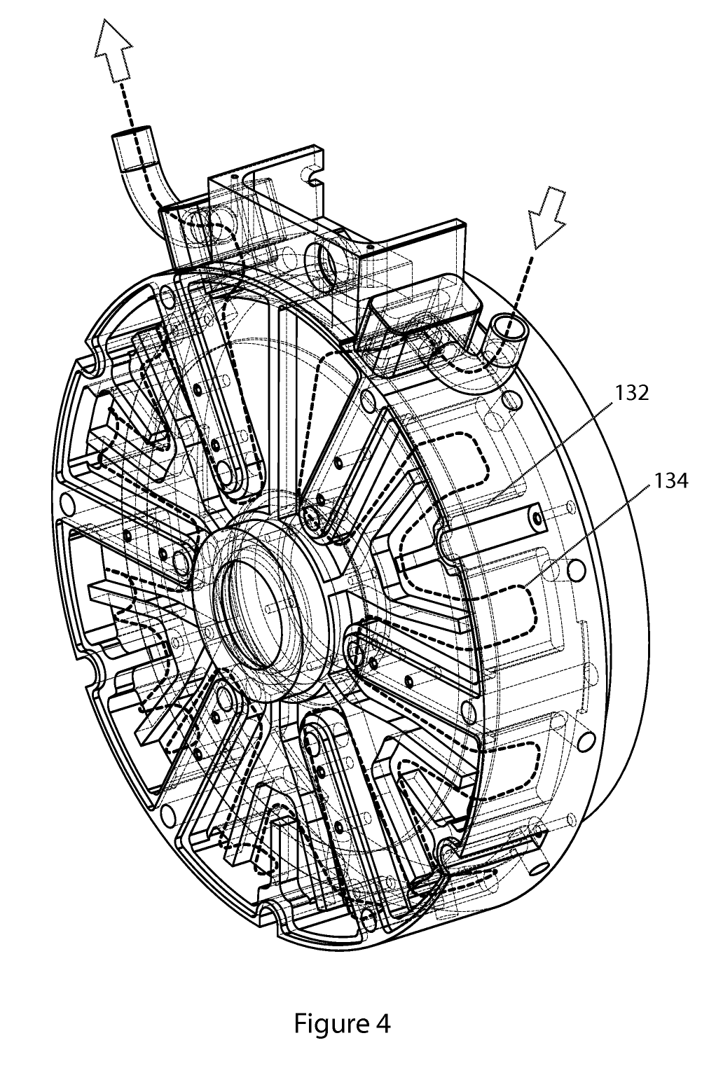

Referring now to FIG. 4 there is shown a plan view of a cavity illustrating a first example of a protrusion configuration that is part of the lid 110 assembly. More specifically, the lid 110 defines a plurality of extending radial protrusions 90 as shown in FIG. 2 which are sized and located to fit within the cavities of the end bell 112 during assembly. This plurality of protrusions 90 modifies fluid flow by increasing the path length for the liquid for optimizing efficient heat transfer within the cavity. When the lid 110 is attached and sealed to the end bell 112, these plurality of protrusions 90 act as flow constrictors in the cavities of the end bell 112 thereby forming the appropriately dimensioned fluid flow channels in accordance with the present invention for providing heat transfer away from the stators and rotors 116 and 114 during operation.

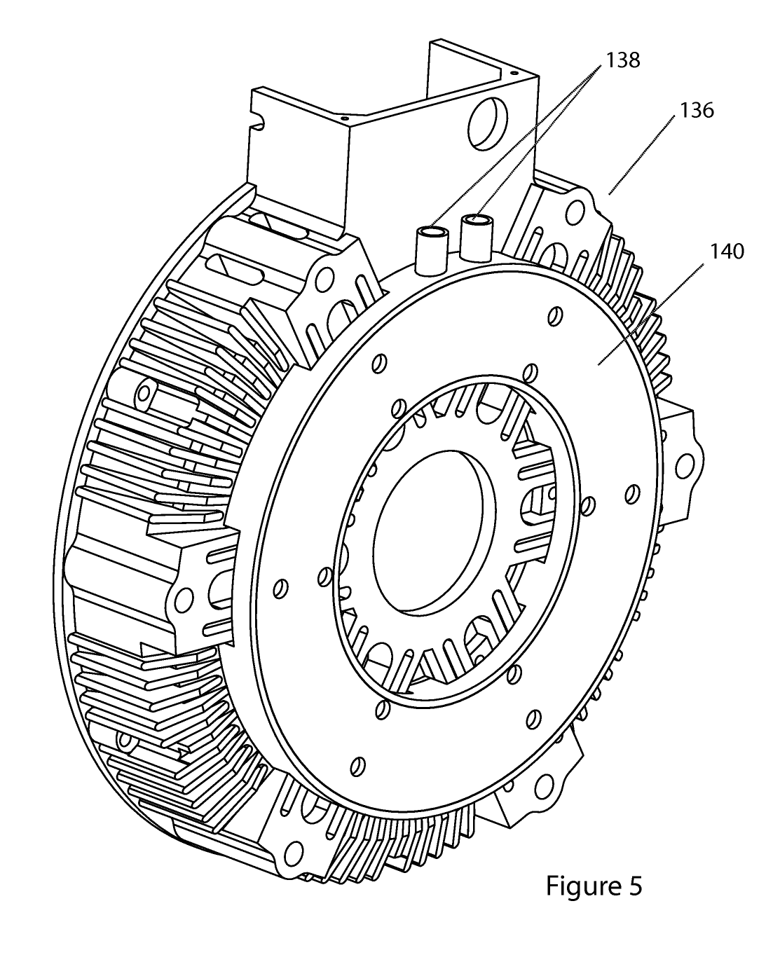

Referring now to FIG. 5 there is shown a plan view assembly of another type of lid 140 having protrusions (not shown) and its associated end bell 136 in an assembled state for providing heat transfer. As shown, in this preferred embodiment, the end bell 136 also defines along its outer contour a plurality of radial thermal heat fins not defined in end bell 112. These fins are machined or stamped and are precisely dimensioned to act as a heat sink. As shown in FIG. 5, the end bell 136 does not define the fluid entry and exit passages as shown and described by the previous end bell 112. This feature is accomplished by lid 140 which is mechanically different than the previous shown and described lid 110 in that lid 140 is a cup-shaped enclosure that also defines the entrance and exit pathways 138 as opposed to being defined by the end bell housing. Regardless, once again, the end bell 136 and lid 140 when assembled provide means for transferring heat away from the stator 114 and rotor 116. However, in this embodiment, even greater thermal offloading may be envisioned since both mechanical and fluid heat transfer means are provided resulting in a combination of heat transfer mechanisms. In this embodiment, fabrication of the end-bell 136 is simplified by making a lid 140 that is slightly more complex resulting in an overall manufacturing cost savings.

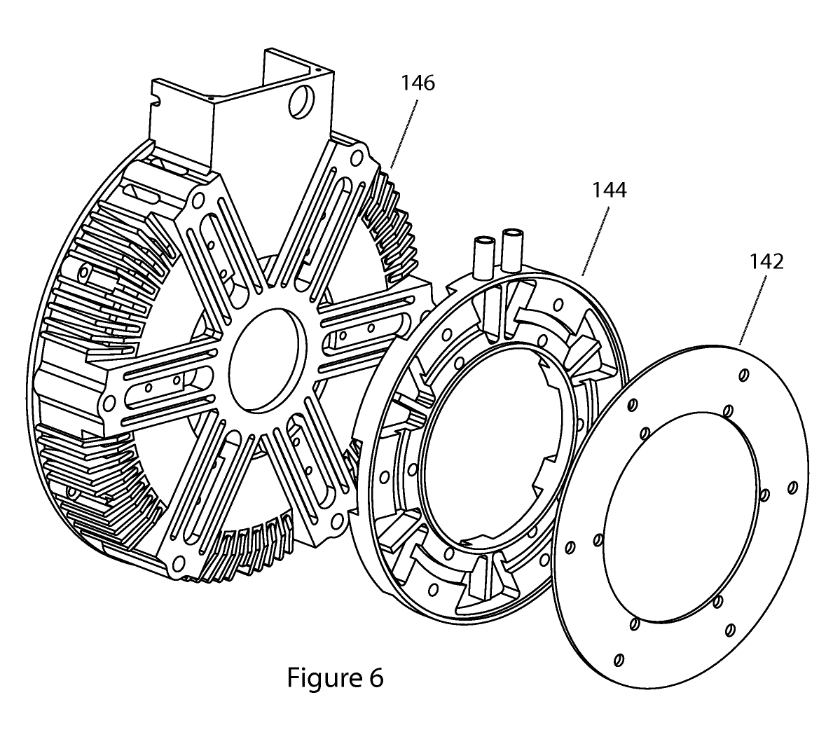

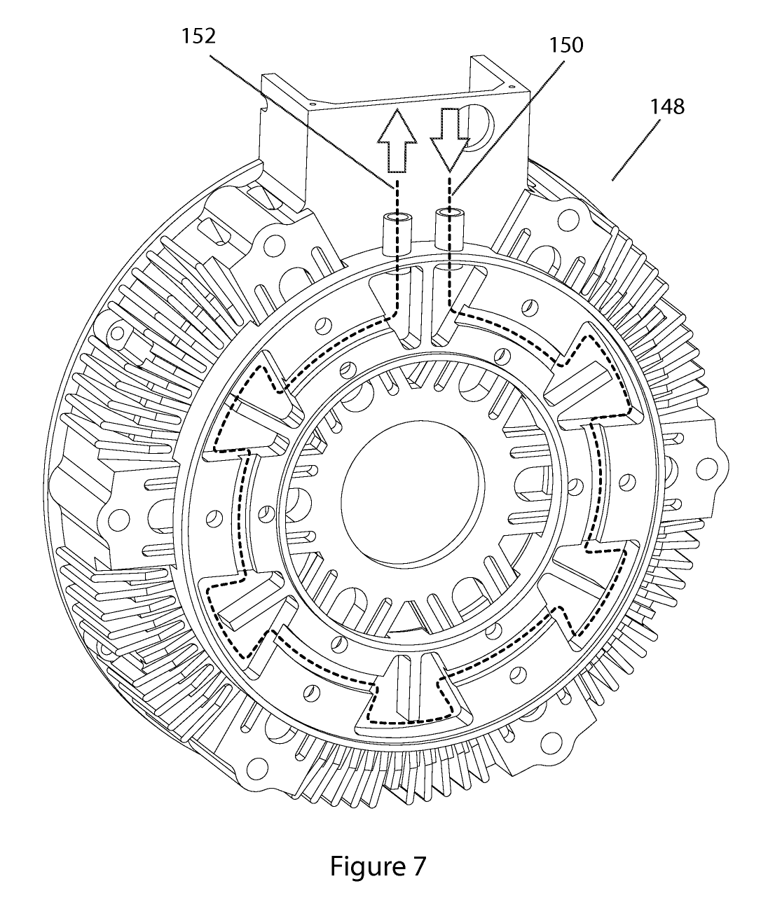

Referring now to FIGS. 5 through 7, the heat transfer means uses a lid 142, fluid channel housing 144 and end bell 146. This assembly of the fluid channel housing 144 to the end bell 146 forms an end bell housings which defines cavities wherein the attachment of lid 142 produces the required fluid flow channels. It should be understood, that the assembly shown in FIG. 7 gives the same heat transfer results that are described above.

In these embodiments, a plurality of outwardly radially located protrusions are disposed along one side of the lid 110 and 120 and extend substantially a distance between the lid 110 and 120 and the back or bottom of a channel defined by its associated end bell 112 and 119. In some embodiments, the protrusions are drawn structures, meaning that while a protrusion is formed on one of an inner surface or an outer surface of the lid 110 or 120, a depression is formed on the other of the inner surface or the outer surface of the end bell 120 or 119. For simplicity in the explanation of the invention in this application, these structures will be referred to as protrusions. It is to be understood that the type of “protrusion” can be any of the foregoing or equivalents thereof. The protrusions which are shown in FIG. 2, define a tortuous path for flow of cooling fluid through the cavity 132 and 134 defined by end bell 112 shown in FIG. 4. The protrusions increase a surface area for dissipating heat from the stator into the fluid flowing throughout and within the end bell 112 and increases turbulence in the cavity 132 and 134 thereby decreasing heat convection resistance. The protrusions additionally provide structural support for end bell 112, and increase stiffness of the lid 110 and 120 to protect it from potential handling damage. The protrusions may be formed in the lid 110 and 120 by for example, stamping, or alternatively by affixing the protrusions to the lid 110 and 120 by, for example, welding. When the lid 110 and 120 is affixed to the end bell 112 and 120 as described above, a labyrinthian flow path is defined in the cavity 132 and 134 as shown in FIGS. 3 and 7.

In summary, a fluid (e.g., liquid or gas) cooling system for cooling the induction machine is disclosed. The fluid cooling system reduces the temperature of induction machine, for example but may not be limited to, the stators and/or the rotors components. In one example, the fluid flow covers a substantial portion of the external contour of the induction machine. In one example, the mechanism for achieving heat flow is by convection. The stators transfer the heat to the end-bells and the entire enclosure by conduction. In one example, the fluid has a specific flow path. And, the design of the flow path is a function of or more of the following: the fluid flow rate, the fluid pressure differential (pressure drop), the inlet fluid temperature and the required outlet fluid temperature.

In one example, the fluid cooling system has substantial (e.g., optimal) contact area between the cooling medium and the induction machine enclosure. FIG. 3 illustrates a frontal view (perpendicular to the front of the axial induction machine) of an example of the fluid path. As shown in FIGS. 3 and 7, the fluid (illustrated as coolant in this example) enters the fluid inlet, flows through the length of the fluid path (e.g., the channels defined after assembly) to cover a substantial space and the fluid exits (illustrated as coolant in this example) through the fluid outlet. Although a specific fluid path is illustrated in FIG. 3, it is an illustrative example. One skilled in the art would understand that other variations of the fluid path may be used without affecting the scope and spirit of the present disclosure.

FIG. 7 illustrates a second embodiment for the fluid path shown in FIG. 3. In this example, the fluid flows from the channels defined within the interior of the end-bell towards and alongside the end-bell circumference. These radial channels are created by partition walls of a lid for directing the fluid. This fluid path is optimized to maximize the cooling effect, i.e., heat transfer from end-bell to the fluid (e.g., coolant). One skilled in the art would understand that other variations of the fluid path may be used without affecting the scope and spirit of the present disclosure. Although the fluid path is illustrated herein in FIG. 3 as being located in end-bell 112, in other aspects, the fluid path may be incorporated in end-bell 119. In one example, two fluid paths are incorporated, one in end-bell 112 and one in end-bell 119 for achieving even greater heat dissipation of the axial induction machine.

While embodiments of the invention have been described above, it will be understood that those skilled in the art, both now and in the future, may make various improvements and enhancements which fall within the scope of the claims which follow. These claims should be construed to maintain the proper protection for the invention first described.

What is claimed is:

1. A liquid cooling system for an electric machine comprising: an end bell conductively attachable to a stator and rotor of an electric machine; a lid mechanically attached and fluidly sealed to said end bell wherein a combination of said lid and said end bell form a fluid cavity for allowing the entrance and exit of a fluid for providing heat transfer used by the electric machine.

2. The liquid cooling system of claim 1 wherein said lid defines a plurality of radially extending protrusions for use in aligning and attaching said lid to said end bell to form said fluid cavity.

3. The liquid cooling system of claim 1 wherein said plurality of protrusions increases turbulence in fluid flowing in said cavity.

4. The liquid cooling system of claim 1 wherein said plurality of protrusions modifies fluid flow in said cavity optimizing efficient heat transfer.

5. The liquid cooling system of claim 1 wherein said plurality of protrusions increases surface area of said cavity.

6. The liquid cooling system of claim 1 wherein said plurality of protrusions extends from said lid and is located within predefined channels formed by said end bell.

7. The liquid cooling system of claim 5 wherein said lid is attached to the end bell by welding, brazing or mechanical attachment.

8. The liquid cooling system of claim 1 wherein at least one protrusion of said plurality of protrusions is an axially elongated structure.

9. The liquid cooling system of claim 1 wherein said end bell defines a plurality of outer heat fins which form a heat sink.

10. The liquid cooling system of claim 1 wherein said end bell defines both fluid entrance and exit pathways.

11. The liquid cooling system of claim 1 wherein said lid is cup-shaped and defines both fluid entrance and exit pathways.

12. A liquid cooling system comprising:
an end bell;
fluid channel housing for attachment to said end bell for forming an end bell cavity;
a lid for attaching to said end bell cavity wherein said attachment defines inlet and outlet fluid pathways for allowing a coolant to provide heat transfer to said cooling system.

13. A method for providing heat transfer for rotors and stators in an axial induction machine, the method comprising the steps of:
defining continuous fluid channels within an interior of an end bell,
defining extruding protrusions from the surface of a lid;
inserting said protrusions into said channels; and
forming fluid flow cavities by attaching said end bell and said lid together.

14. The method according to claim 13, further comprising the step of:
increasing path length in fluid flowing in said cavity by dimensioning said plurality of protrusions.

15. The method according to claim 13, further comprising the step of:
restricting fluid flow in said cavity by dimensioning said plurality of protrusions.

16. The method according to claim 13, further comprising the step of:
increasing surface area of said cavity by dimensioning said plurality of protrusions.

17. The method according to claim 13, further comprising the step of:
attaching said lid to said end bell by welding.

18. The method according to claim 13, further comprising the step of:
attaching said lid to said end bell by brazing.

19. The method according to claim 13, further comprising the step of:
providing a fluid inlet and a fluid outlet within said end bell for controlling fluid flow rate, pressure differential and temperature.

20. The method according to claim 13, further comprising the step of:
Forming a channel housing affixed between said lid and said end bell for fluid flow control.
